(19) United States
(12) Patent Application Publication
(10) Pub. No.: US 2008/0235048 A1
(43) Pub. Date: Sep. 25, 2008

(54) Roaming agreements in a wideband wireless system

(75) Inventors: Tommi O. Rantanen, Tampere (FI); Jukka Ala-Vannesluoma, Tampere (FI); Jani Hirsimaki, Tampere (FI); Mikko Tasa, Tampere (FI)

Correspondence Address: HARRINGTON & SMITH, PC, 4 RESEARCH DRIVE, SHELTON, CT, 06484-6212, US

(73) Assignee: Nokia Corporation

(21) Appl. No.: 12/077,817

(22) Filed: Mar. 21, 2008

Related U.S. Application Data
(60) Provisional application No. 60/919,796, filed on Mar. 22, 2007.

(51) Int. Cl. G06Q 99/00

(52) U.S. Cl. 705/1

(57) ABSTRACT

A terminal's home network service provider H-NSP determines that the terminal is connected to an access provider, and sends to the terminal a list of access providers and a list of service providers. The list of access providers indicates the H-NSP's preferences of the listed access providers relative to one another, and the list of service providers indicates the H-NSP's preferences of the listed service providers relative to one another. The terminal receives the list and connects to an access provider and a service provider according to the preferences indicated. Methods, apparatus, and software/hardware/firmware is detailed for implementing these aspects, from the H-NSP, V-NSP and terminal's perspectives. Much additional information is described that may be included in the preference lists according to various embodiments, and the invention is particularly advantageous for use in a WiMAX system.

### CROSS REFERENCE TO RELATED APPLICATION

This patent application claims priority under 35 U.S.C. §119(e) from U.S. Provisional Patent Application No.: 60/919,796, filed Mar. 22, 2007, the disclosure of which is incorporated by reference herein in its entirety.

### TECHNICAL FIELD

The exemplary and non-limiting embodiments of this invention relate generally to wireless communications systems and, more specifically, relate to preferential access in a wideband wireless communication system such as WiMAX that includes multiple access providers and multiple service providers.

### BACKGROUND

The following abbreviations are herewith defined:

AAA authentication, authorization and accounting

ASN access services network

BS base station (or other wireless access node)

CAPL contractual agreement preference list

DMO device management object

H-NSP home NSP

HA home agent

MAC medium access control

NAP network access provider

NSP network service provider

NWG network working group

PHY physical layer

QoS quality of service

RAPL roaming agreement preference list

SBC subscriber basic capability

SOHO small office/home office

TFTP trivial file transfer protocol

V-NSP visited-NSP

WiMAX worldwide interoperability for microwave access

WiMAX system lends itself as a lightweight Internet access technology. It is built on top of the IEEE 802.16e MAC+PHY standard from IEEE (certified by WiMAX). The system standard (higher layers and network) are standardized and certified by a body known as the WiMAX Forum. While IEEE 802.16e standardization was completed in December 2005, the WiMAX Forum standardization is still ongoing and it is currently finalizing its Release 1 documents.

Unlike many other more mature wireless technologies, WiMAX differentiates between network service providers and network access providers. Examples of network service providers include traditional Internet service providers ISPs, virtual wireless ISPs, and the like. A network service provider is characterized in that it maintains a service level agreement SLA with individual subscribers. Relevant to this invention is wireless network service providers. Network access providers operate base stations that wirelessly interface subscriber terminals to the networks stipulated in the SLA. Of course, the network service providers might also serve as network access providers as when they operate their own base stations.

WiMAX uses the terminology network access providers (NAP) and network service providers (NSP) to maintain the distinction, and that terminology is continued herein though its use is in a more generic sense and not limited only to WiMAX. An NAP may be connected to one or more NSPs whenever there is a contractual agreement between the NAP and the NSP. In addition, an NSP may connect to other NSPs by having a roaming agreement between each other.

A schematic diagram showing these distinctions is illustrated at FIG. 2. A WiMAX subscriber 202 has a service level agreement SLA 204 with a network service provider, its home NSP 206. Consider the various NAPs as private companies that hold rights to operate networks in the named cities. A first NAP 208 operates in Chicago, and has a direct contractual agreement 210 with the home NSP 206. When the WiMAX subscriber 202 seeks network access at Chicago, it goes through the Chicago ASN which is operated by the first NAP 208. Since the first NAP 208 has a contractual relationship with the home NSP 206, invoicing and billing for access services provided to the subscriber 202 are typically according to the terms of the contract 210.

Now the subscriber 202 seeks access from another location, for example through an ASN in LA, NYC, or Miami as shown in FIG. 2. Those ASNs are operated by a second NAP 212, and the second NAP has a contractual agreement 214 with a different NSP, which (from the perspective of the subscriber 202) is termed the visited NSP 216. Since the subscriber 202 only has an SLA with one NSP, the home NSP 206, there is a roaming agreement 218 between the home NSP 206 and the visited NSP 216 which enables 1) the home NSP 206 to promise service to the subscriber beyond the limits of its own network coverage and 2) the visited NSP 216 to be paid for allowing the subscriber 202 use of its network (via the NAP 212). FIG. 2 includes a layer of NAPs 208, 212 between the NSPs 206, 216 and the subscriber 202 that is additional to what is normally found in an arrangement of traditional mobile telephony networks, which only needed roaming agreements 218 with other service providers.

Subscriber terminals obtain information about available NAPs by scanning different frequencies, whereas information about NSPs that the NAPs support is obtained through either or both SII-ADV (advertisement) or SBC-RSP (response) messages. The network uses the SII-ADV message to periodically broadcast a list of NSP identifiers, and uses the SBC-RSP during a negotiation of which subscriber capabilities it will support, in reply to the subscriber's companion SBC-REQ (request) message. Subscriber terminals must have some way to determine through which NAP it connects to its Home NSP 206. It could do this by using any available NAP (e.g., the first NAP 208) that advertizes the identifier NSP ID (identifier) of its Home NSP 206. However, the home NSP 206 may want to define preferences regarding which NAP to use. Furthermore, if the home NSP 206 is not supported by any of the available NAPs (e.g., the second NAP 212), the subscriber terminal 202 must have some means to select another NSP (namely a visited-NSP 216) through which to connect to the home NSP 206. Also in this case, the home NSP 206 may want to prefer some V-NSP over the other. These preferences may be given as two lists: Contractual Agreement Preference List (CAPL) and Roaming Agreement Preference List (RAPL). These names are not formally defined in WiMAX currently and their use herein is generic.

In more traditional mobile telephony networks (e.g., code division multiple access CDMA and global system for mobile communications GSM), there is only one preference list because those systems do not have a concept of different access and service providers. The subscriber terminal 202 would have this preference list information stored into its configuration information, and is thereby able to select the preferred roaming partner to connect to in the event the home network is not available.

The current assumption in developing WiMAX is that the subscriber terminals store both the CAPL and the RAPL locally. This is seen to be an extension of the single preference-list solution used in GSM(CDMA noted above, and would enable the subscriber terminal to select a preferred NAP, or a preferred V-NSP for the case where the H-NSP is not reachable via any of the available NAPs.

The inventors have determined that supporting of the GSM/CDMA/WiMAX preference-list presents problems. Specifically, if the CAPL and RAPL (or equivalent preference lists in other technologies) are stored into the configuration information of the subscriber terminal, and that subscriber terminal has to respect that configuration information always and without question, the following problems exist:
a) The subscriber terminal needs to scan all the available BSs to be able to select the correct NAP based on the CAPL. This will take a lot of time unless the first NAP in the CAPL is found quickly (which cannot be assumed to be true).
b) The network must update all devices (millions of subscriber terminals) whenever the CAPL or RAPL changes. Such a change occurs whenever new agreements are made either with NAPs or V-NSPS, or whenever the H-NSP changes its preferences due to changing agreements with their existing partners. Such a frequent updating process would consume a lot of air interface traffic. Of course, the usage of air interface traffic would be reasonable if the information that is transferred would be needed by most of the terminals. However, only a relatively few subscriber terminals ever roam (such as a desktop computer with network access only through a SOHO AP), and hence they don't need those lists or updates. Furthermore, only a very small portion of the roaming subscriber terminals will need exactly the update that was pushed to the terminal at a particular time.
c) The CAPL and RAPL may be very large lists and the subscriber terminal has to store them into its memory. The number of items in these lists can be hundreds or even thousands. Further, if CAPLs of V-NSPs will also be stored, then the list would expand exponentially. Larger lists not only occupy more of the terminal's limited memory, they indicate on average longer scans as detailed at point a) above.

What is needed in the art is a way to enable the home NSP's preferences as to NAP and V-NSP to be followed by its subscriber stations, without the disadvantages seen above for the solution of extending the single preference list used in GSM/CDMA to dual preference lists of CAPL and RAPL in WiMAX. Furthermore, advantages of the invention detailed below for supporting dual preference lists of CAPL and RAPL without the above disadvantages applies also to the technologies using single preference lists.

### SUMMARY

In accordance with an exemplary embodiment of the invention is a method that includes determining that a terminal is connected to an access provider, and sending to the terminal from the terminal's home service provider a list of access providers and a list of service providers, wherein the list of access providers indicates preferences of the listed access providers relative to one another and the list of service providers indicates preferences of the listed service providers relative to one another.

In accordance with another exemplary embodiment of the invention is an apparatus that includes a processor executing a program that is stored in a memory that operates to determine that a terminal is connected to an access provider, and to send to the terminal a list of access providers and a list of service providers, wherein the list of access providers indicates preferences of the listed access providers relative to one another and the list of service providers indicates preferences of the listed service providers relative to one another.

In accordance with still another exemplary embodiment of the invention is a method that includes receiving a list of access providers and a list of service providers, wherein the list of access providers indicates preferences by a terminal's home service provider of the listed access providers relative to one another and the list of service providers indicates preferences by the terminal's home service provider of the listed service providers relative to one another. The method further includes connecting to an available access provider and to an available service provider according to the indicated preferences.

In accordance with yet another exemplary embodiment of the invention is an apparatus that includes a receiver, a processor, a memory and a transmitter. The receiver is configured to receive a list of access providers and a list of service providers, wherein the list of access providers indicates preferences by a terminal's home service provider of the listed access providers relative to one another and the list of service providers indicates preferences by the terminal's home service provider of the listed service providers relative to one another. The transmitter, processor, memory and receiver are configured so that together they connect to an available access provider and to an available service provider according to the indicated preferences.

And in accordance with still a further exemplary embodiment of the invention is a computer readable memory that embodies a program of machine-readable instructions executable by a digital data processor to perform actions directed toward connecting to a preferred access provider and to a preferred service provider. In this embodiment of the invention the actions include, in response to receiving a list of access providers and a list of service providers, connecting to an available access provider and to an available service provider according to the preferences indicated in the lists. The list of access providers indicates preferences by a terminal's home service provider of the listed access providers relative to one another, and the list of service providers indicates preferences by the terminal's home service provider of the listed service providers relative to one another.

In accordance with an additional exemplary embodiment of the invention is an apparatus that includes receiving means for receiving receive a list of access providers and a list of service providers, wherein the list of access providers indicates preferences by a terminal's home service provider of the listed access providers relative to one another and the list of service providers indicates preferences by the terminal's home service provider of the listed service providers relative to one another. The apparatus further includes storing means for storing the received lists, and transmitting means for connecting, in conjunction with the receiving means, to an available access provider and to an available service provider according to the indicated preferences. In a particular embodiment, the receiving means includes a receiver, the storing means includes a local computer-readable memory, and the transmitting means includes a transmitter.

### BRIEF DESCRIPTION OF THE DRAWINGS

Embodiments of the invention are detailed below with particular reference to the attached drawing Figures.

FIG. 1 shows a simplified block diagram of various electronic devices that are suitable for use in practicing the exemplary embodiments of this invention.

FIG. 2 is a schematic illustration of a subscriber terminal and its home network service provider, and also various intervening providers that provide services to the terminal and that have agreements directly or indirectly with the home network service provider.

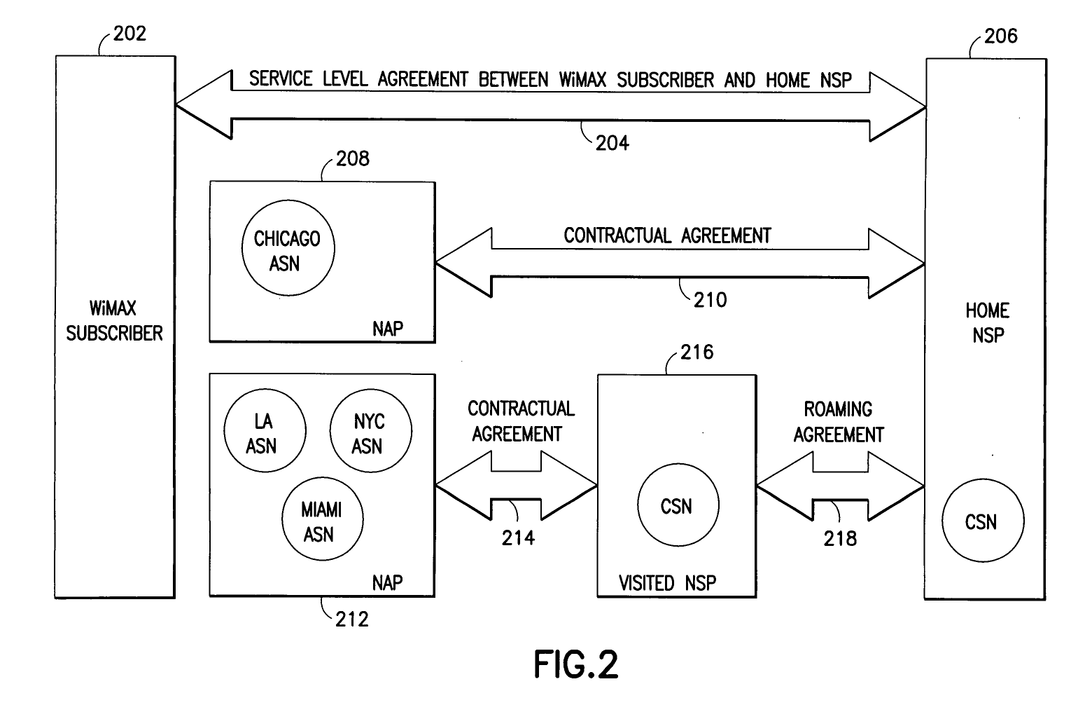

FIG. 3 illustrates relationship architecture between a terminal and a home network service provider that goes between four access nodes or NAPs and two visiting network service providers.

FIG. 4 is a signaling diagram illustrating a terminal initiated inter-access point handover according to preferences of the home network service provider where no visiting network service providers are involved.

FIG. 5 is similar to FIG. 4 but where the handover is initiated by the home network service provider.

FIG. 6 is similar to FIG. 5 but where multiple visiting service providers are included and the handover is both inter-service provider and inter-access provider.

FIG. 7 is similar to FIG. 6 but where the handover is initiated by the network.

### DETAILED DESCRIPTION

Embodiments of this invention employ versions of the CAPL and RAPL, but the versions stored in the subscriber terminal are not the entire lists themselves but are dynamically configured subsets of the CAPL and RAPL that are tailored to avoid the problems detailed above, and also to meet the demonstrated need of the terminal for only a portion of those lists.

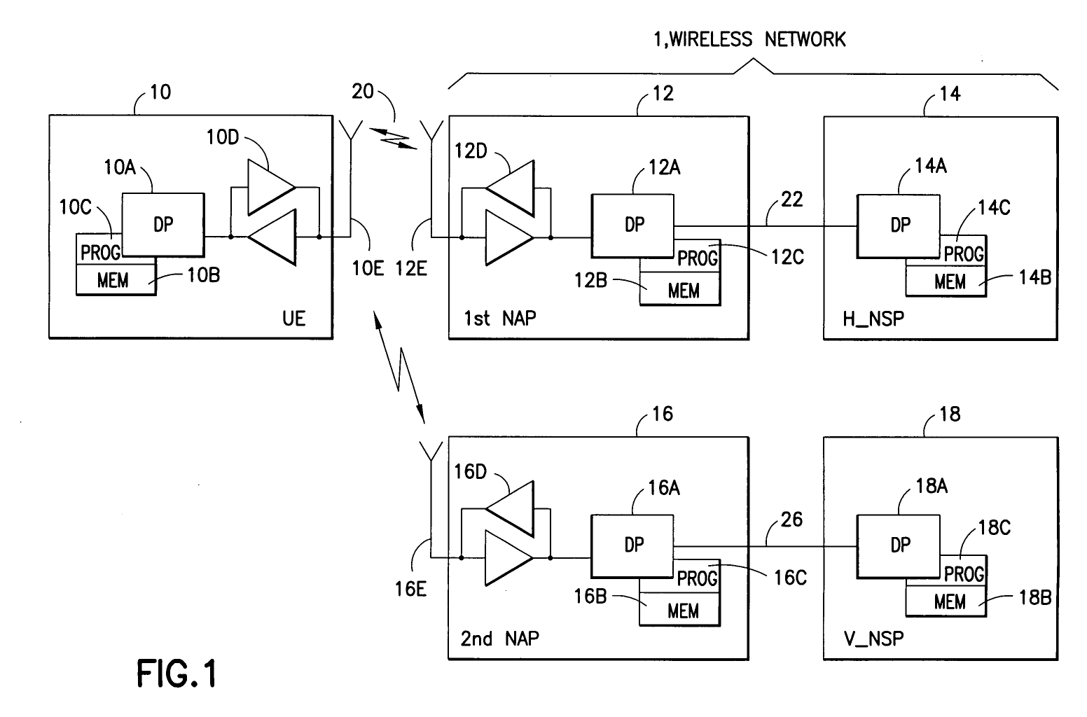

Reference is made first to FIG. 1 for illustrating a simplified block diagram of various electronic devices that are suitable for use in practicing the exemplary embodiments of this invention. In FIG. 1 a first wireless network 1 is adapted for communication with a mobile user equipment/subscriber station 10 via a first network access provider NAP 12 (e.g., via a BS of the first NAP). The first network 1 includes a higher node 14 of the home network service provider H-NSP. The UE 10 includes a data processor (DP) 10A, a memory (MEM) 10B that stores a program (PROG) 10C, and a suitable radio frequency (RF) transceiver 10D and one or more antennas 10E for bidirectional wireless communications over a wireless link 20 with the first NAP 12, which also includes a DP 12A, a MEM 12B that stores a PROG 12C, and a suitable RF transceiver 12D with one or more antennas 12E. The first NAP 12 may be coupled via a data path 22 (e.g., hardwired as in an Iub, or wireless as between an NAP and an NSP) to the higher node 14 of the H-NSP. Where the data path 22 is wireless, the higher node 14 also includes a transceiver and one or more antennas (not shown), otherwise only a modem need be used if the data path 22 is a hardwire connection. At least one of the PROGs 10C and 14C is assumed to include program instructions that, when executed by the associated DP, enable the electronic device to operate in accordance with the exemplary embodiments of this invention, as will be discussed below in greater detail. Also, the MEMs 10B and 14B store the preference lists detailed herein.

Also shown in FIG. 1 is a second NAP 16 having a bidirectional wireless link 24 with the UE, such as where the UE 10 sees both the first NAP 12 and the second NAP 16 and a) must choose which one to connect to on an initial connection; and/or b) whether or not to handover to the other of the NAPs such as by its own request or as directed by the network, as will be detailed below. The second NAP 16 also includes a DP 16A, MEM 16B, PROG 16C, transceiver 16D and one or more antennas 16E like the first NAP 12. The second NAP 16 may provide access to the UE 10 via a higher node 18 of a V-NSP. That higher node 18 includes its own DP 18A, MEM 18B and PROG 18C, and is coupled to the second NAP 16 by a data link 26 similar to that detailed above between the H-NSP higher node 16 and the first NAP 14. Where the second NAP 16 is coupled to a node 18 of a V-NSP, the pair may be considered a second wireless network. As will be seen in embodiments detailed below, the second NAP 16 may instead be coupled via the data link 26 to the higher node 14 of the H-NSP rather than the node 18 of the V-NSP, such as where the H-NSP has a preference of one NAP over another NAP and there no V-NSP intervenes between the H-NSP and either NAP. In such a case both the first NAP 12 and the second NAP 16 are part of the first wireless network 1 with the higher node 14 of the H-NSP. Below, the term subscriber terminal is used to refer to a user equipment that is under a SLA with a home NSP.

In general, the various embodiments of the UE 10 can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The MEMs 10B, 12B, 14B, 16B and 18B may be of any type suitable to the local technical environment and may be implemented using any suitable data storage technology, such as semiconductor-based memory devices, magnetic memory devices and systems, optical memory devices and systems, fixed memory and removable memory. The DPs 10A, 12A, 14A, 16A and 18A may be of any type suitable to the local technical environment, and may include one or more of general purpose computers, special purpose computers, microprocessors, digital signal processors (DSPs) and processors based on a multi-core processor architecture, as non-limiting examples.

In general, the subscriber terminal 10 follows two rules for connecting to any NAP:
If the subscriber terminal does not have a CAPL, it can connect to the first NAP that supports the H-NSP. Then, either network or terminal may initiate/force a handover to an NAP that is preferred by H-NSP.
If the subscriber terminal's H-NSP is not accessible by any of the available NAPs and the terminal does not have an RAPL, the terminal could try different NSPs and check whether they are able to connect the terminal into the H-NSP by means of roaming. As will be seen in the detailed embodiments below, either the network or the terminal may initiate/force a handover to a V-NSP that is preferred by H-NSP.

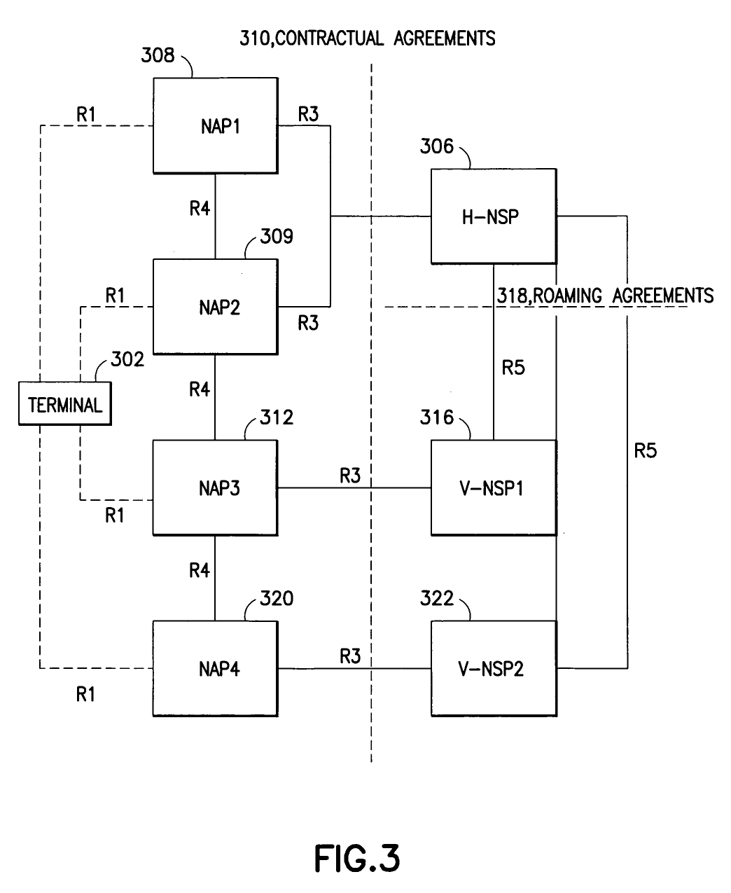

Now are described embodiments of the invention with reference to the relationship architecture of FIG. 3. FIG. 3 illustrates a single subscriber terminal 302 which has a SLA with the H-NSP 306. Each of a first NAP (NAP1) 308 and a second NAP (NAP2) 309 has a contractual agreement 310 with the H-NSP 306. Also is shown a third NAP (NAP3) 312 that has a contractual agreement 310 with a first V-NSP 316, and a fourth NAP (NAP4) 320 that has a contractual agreement with a second V-NSP 322. Each of the first V-NSP 316 and the second V-NSP 322 has a roaming agreement 318 with the H-NSP 306. Assume for FIG. 3 that where there is no line R3 indicating a contractual agreement 310, and no line R5 indicating a roaming agreement 318, then none exists (e.g., there is no contractual agreement between the third NAP 312 and the H-NSP 306). From FIG. 3 then, there are only four distinct paths by which the subscriber terminal 302 can connect to its H-NSP 306: via the first NAP 308; via the second NAP 309; via the third NAP 312 and the first V-NSP 316, and via the fourth NAP 320 and the second V-NSP 322.

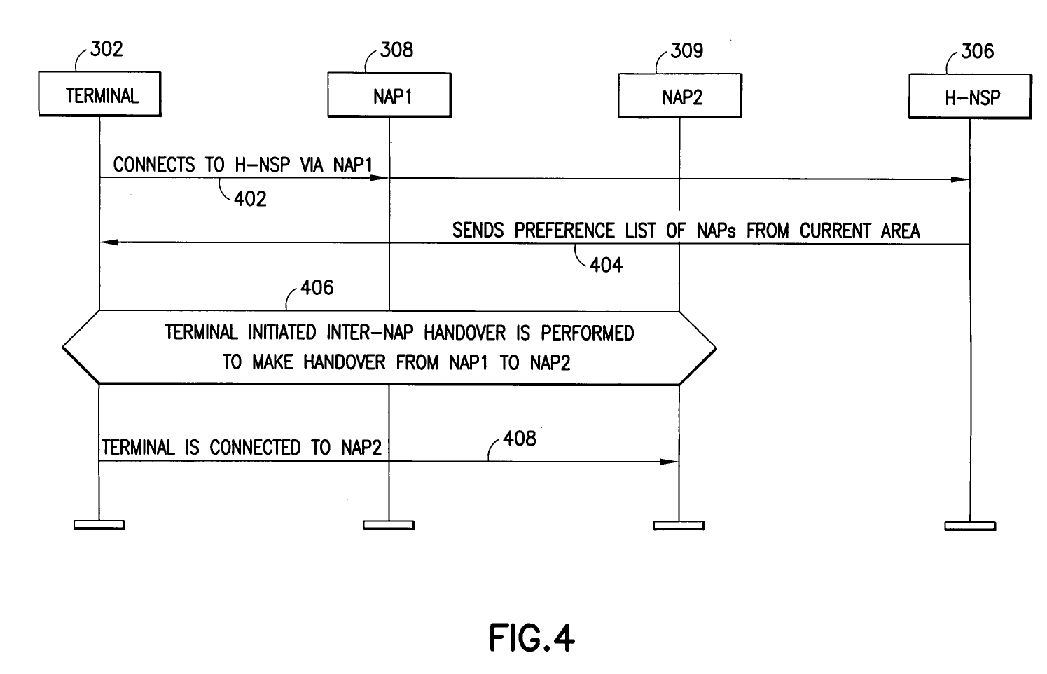

For the specific examples given in the detailed embodiments of FIGS. 4-7, further assume for FIG. 3 that the H-NSP 306 makes the following preferences:
The second NAP 309 is preferred over the first NAP 308; and
The second V-NSP 322 is preferred over the first V-NSP 316.
   These preferences for the NAPs are reflected/embodied in the CAPL, and the preferences for the V-NSP are reflected/embodied in the RAPL.

FIGS. 4-7 are signaling diagrams illustrating each of the four pathways between subscriber station and H-NSP shown in FIG. 3. FIG. 4 is described first and illustrates a handover from one NAP to another that is initiated by the subscriber terminal. From their broadcast information, the subscriber terminal 302 ‘sees’ both the first NAP 308 and the second NAP 309. The subscriber terminal 302 first connects 402 quickly to the first NAP 308. The H-NSP 306 becomes aware that the subscriber terminal 302 is connected through the first NAP 308 because the H-NSP 306 provides service to the subscriber terminal 302 through the first NAP 308 according to the contractual agreement 310. The H-NSP 306 then sends to the subscriber terminal 302, via the first NAP 308, a tailored list of NAPs for the current area 404 in which the subscriber terminal 302 is located. This tailored list is a subset of the total CAPL that the H-NSP 306 keeps, and the H-NSP 306 knows which subset of the total CAPL to send to the subscriber terminal in message 404 by any number of means, including knowing the location of a BS of the first NAP 308 to which the subscriber terminal 302 is connected, and specific location information of the subscriber terminal 302 (provided by the terminal 302 itself of the first NAP 308) that was used in establishing the terminal 302 with the first NAP 308, to name a few. Responsive to receiving the tailored preference list/subset of the total CAPL, and conditioned on the subscriber terminal 302 still being within range/signal strength of the second NAP 309, the subscriber terminal 309 then initiates a handover 406 from the first NAP 308 to the second NAP 309 since the second NAP 309 is higher on the preference list than the first NAP 308. Once the handover is completed, the subscriber terminal 302 is connected 408 to the H-NSP 306 through the second NAP 309, in accordance with the policies of the H-NSP 306 embodied in the tailored NAP list 404.

One method for executing the embodiment of FIG. 4 is as follows:
a) The terminal 302 starts to search for available networks and sees that the first NAP 408 is available and that it has direct connection to the H-NSP 306. The terminal 302 decides to connect to the H-NSP 306 via the first NAP 308 by performing normal network entry at step 402.
b) The H-NSP 306 checks the location of the terminal 302 (at the level of the first NAP 308, the controlling BS, or exact coordinates of the terminal 302) and transfers 404 to the terminal a small CAPL list from the area that the terminal 302 is located. This may be done by means of device management, TFTP, new WiMAX MAC messaging or by any other means which can be either subscriber terminal or network initiated.
c) When the terminal 302 has the CAPL for its current area, it is able to initiate an inter-NAP handover 406 to the most preferred NAP, that is, the second NAP 309. This can be done because the terminal 302 has had time to obtain more information about surrounding NAPs (the terminal knows that also second NAP 309 is an alternative) by means of background scanning or received MOB_NBR-ADV (‘mobile’ neighbour advertisement) messages (which the BSs transmit in order to facilitate handovers).
d) The result is that the terminal 309 is connected 408 to the best possible NAP according to policies of H-NSP 306.

The subscriber terminal 302 locally stores that small CAPL for later access whenever it is in that area again. The subscriber terminal 302 can then connect directly to the most preferred NAP in the same area whenever it tries to enter to the network at a later time/date because it has this small CAPL for that area stored on a local memory within the terminal 302. Also, the subscriber terminal 302 is able to perform inter-NAP handovers in that area to a more preferred NAP whenever it is connected to one NAP and another with higher priority on the small CAPL list becomes available. This is true whether the small CAPL was downloaded 404 on the current connection with the network or at some previous time/date and recalled for use with the current connection.

Steps b) through d) may be performed after initial service flows have been established, or alternatively prior to establishing those service flows in order to avoid re-location of the data path and possibly other components as well. These are implementation details that can be optimized without departing from the broader teachings of this invention.

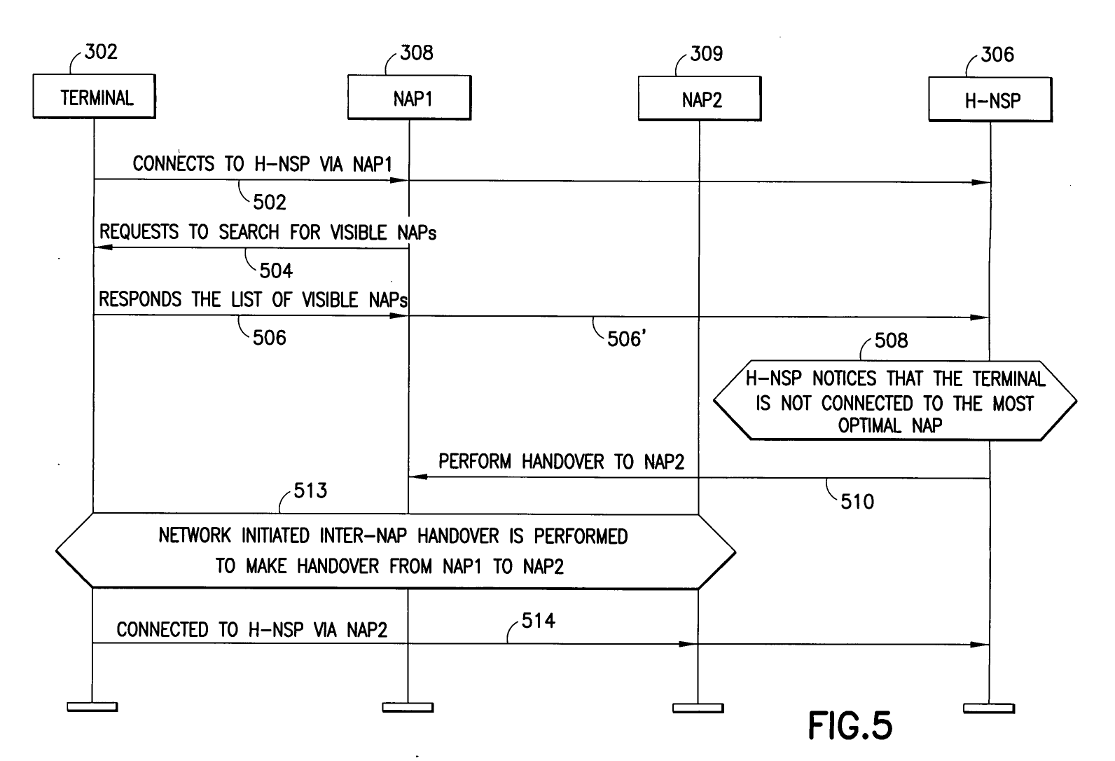

Next is described a network initiated handover. FIG. 5 illustrates a scenario where the subscriber terminal 302 again sees the first NAP 308 and the second NAP 309. The subscriber terminal 302 first connects 502 quickly to the first NAP 308, and then the network initiates a handover to the second NAP 309 because it is preferred according to the H-NSP 306 policies over the first NAP 308.

One method of executing a method according to FIG. 5 is as follows:
a) The subscriber terminal 302 starts to search for available networks and sees that the first NAP 308 is available and that it has direct connection to the H-NSP 306. The subscriber terminal 302 decides to connect to the H-NSP 306 via the first NAP 308 by performing normal network entry 502.
b) The first NAP 308 requests the subscriber terminal 302 to search for visible NAPs 504 (e.g. by means of normal scanning procedure, for example a MOB_SCN-RSP (scanning interval allocation response) message that the serving BS of the NAP sends to the subscriber terminal and which includes information to be scanned by the terminal. The terminal then scans for pilot carrier interference to noise ratio CINR of neighbor base stations that it recognized from this or previous messages). The request may have originally come from the H-NSP 306.
c) The subscriber terminal 302 responds with the visible NAPs 506 (e.g. by means of MOB_SCN-REP (scanning result report) message, the report message in response to the scan performed after the MOB_SCN-RSP message) to the first NAP 308, which forwards 506′ the information to the H-NSP 306. This may be part of a normal inter-NAP handover procedure.
d) The H-NSP 306 gets a list 506′ of NAPs that the terminal can see and notices 508 from its CAPL (short CAPL for the terminal's area or the total CAPL) that the terminal 302 is not connected to the most preferred one (the second NAP 309). The H-NSP 306 can find its CAPL, for example, from its AAA server or any other entity.
e) The H-NSP 306 initiates a handover from the first NAP 308 to the second NAP 309 by commanding 510 the first NAP 308 to make it.
f) A network initiated inter-NAP handover 512 is performed normally.
g) The result 514 is that the terminal 302 is connected to the H-NSP 306 via the second NAP 309, which is the most preferred one of those which the terminal 302 can see (list of visible NAPs 506).

As with the terminal-initiated handover at FIG. 4, when the subscriber terminal 302 undergoes a network initiated handover such as shown in FIG. 5, the subscriber terminal 302 can connect directly to the most preferred NAP in the same area whenever it tries to enter to the network at a later time/date because the network has forced a handover to the second NAP 309 rather than keeping the connection to the first NAP 308. The subscriber terminal simply records this in its local memory as a network preference, the second NAP 309 over the first NAP 308. While listing only two NAPs at this point, the result is the terminal 302 showing the same relative preference for these two NAPs as when the small CAPL was downloaded to it in FIG. 4. Also, the terminal 302 is able to perform inter-NAP handovers in that area to a more preferred NAP whenever it can see both of them, since the preference is stored in its local memory. Hence, the terminal 302 learns the preferences while it traverses in different areas and builds its own small CAPL that is identical in relevant parts to the download small CAPL described at FIG. 4.

Steps b) through g) may be performed after initial service flows have been established, or alternatively before those service flows are established in order to avoid re-location of data paths (and possibly other components) and the start of accounting.

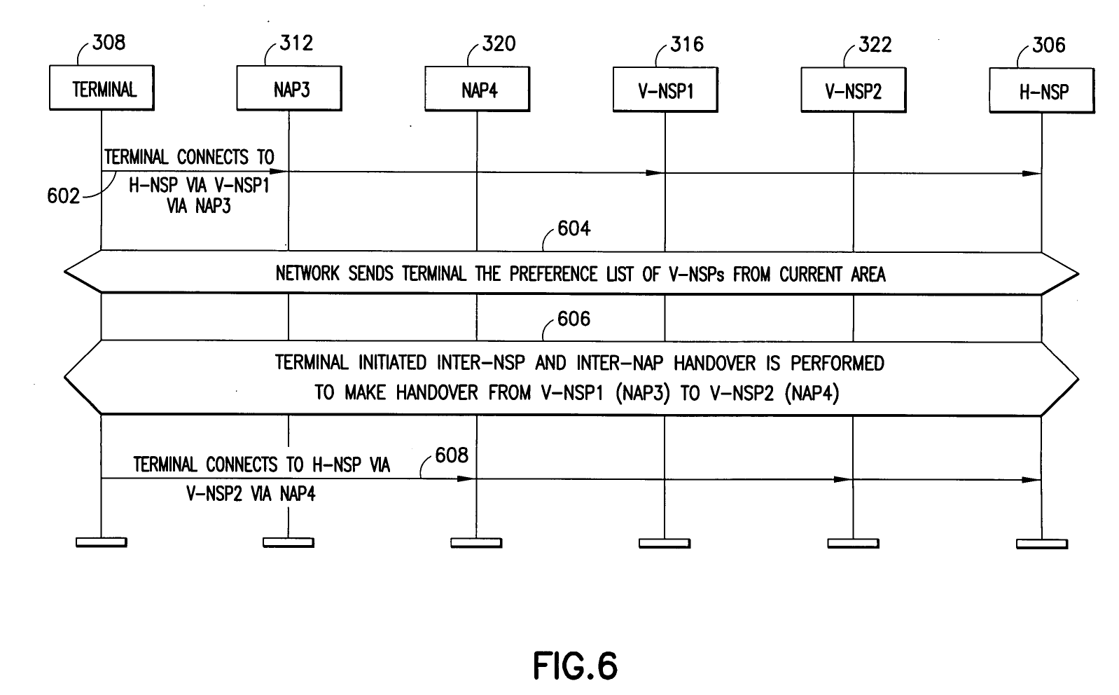

Now are described the two remaining connection options from FIG. 3, where the subscriber terminal 302 connects to a NAP that is served by a visiting NSP 316/322. First is detailed a terminal initiated handover. FIG. 6 illustrates a scenario where terminal sees the third NAP 312 and the fourth NAP 320. The terminal 302 first connects to the H-NSP 306 via the first V-NSP 316 and the third NAP 312, and then performs a handover to the second V-NSP 322 via the fourth NAP 320 because it is more preferred according to the H-NSP 306 policies.

A method for executing the signaling diagram of FIG. 6 is as follows:
a) The subscriber terminal 302 starts to search for available networks and sees that the third NAP 312 is available. The terminal 302 connects 602 to the H-NSP 306 via the first V-NSP 316 and the third NAP 312 either by just trying its luck and connecting to any available NAP/NSP, or by getting information about V-NSPs that the H-NSP 306 supports. As one example, the terminal 302 may get information about V-NSPs supported by the H-NSP in a message such as the SBC-RSP (subscriber station basic capability response) message, as detailed in provisional US patent application entitled “Network Search, Selection and Entry in WiMAX”, filed on Jan. 24, 2007 and attached hereto as Appendix A of the provisional US patent application that is priority to this one.
b) The H-NSP 306 checks the location of the terminal 302 (at the level of the NAP, the serving BS or the exact coordinates) and transfers 604 to the terminal 302 a small CAPL and a small RAPL list for the area in which the terminal 302 is located. Also, the CAPLs of the V-NSPs listed in the small RAPL may be transferred. This may be done for example by means of device management, TFTP, new WiMAX MAC messaging or by any other means which can be either subscriber terminal or network initiated.
c) The terminal 302 initiates a handover 606 where both V-NSP is changed (from the first V-NSP 316 to the second V-NSP 322) and the NAP is changed (from the third NAP 312 to the fourth NAP 320). Also, this may include relocation of the home agent HA. If inter-NSP handover is not possible, the terminal 302 may perform NSP change as hard handover (by exiting from first V-NSP 316 and entering into the second V-NSP 322) when the user is not using any data services.
d) The result 608 is that the terminal 302 is connected to the H-NSP 306 via the second V-NSP 322 via the fourth NAP 320, which is preferred over the first V-NSP 316 and any of its NAPs.

The terminal 302 can connect directly to the most preferred V-NSP in the same area whenever it tries to enter to the network at a later time/date because it has the small CAPL and small RAPL for that area (the relevant subsets of the CAPL and RAPL). Also, the terminal 302 is able to perform inter-NSP handovers in that area to more preferred V-NSP using the preferences downloaded at step 604, which the subscriber terminal 302 stores in its local memory.

Steps b) through d) may possibly be performed after initial service flows have been established, or alternatively before that to avoid re-location of data path and possibly other components as well.

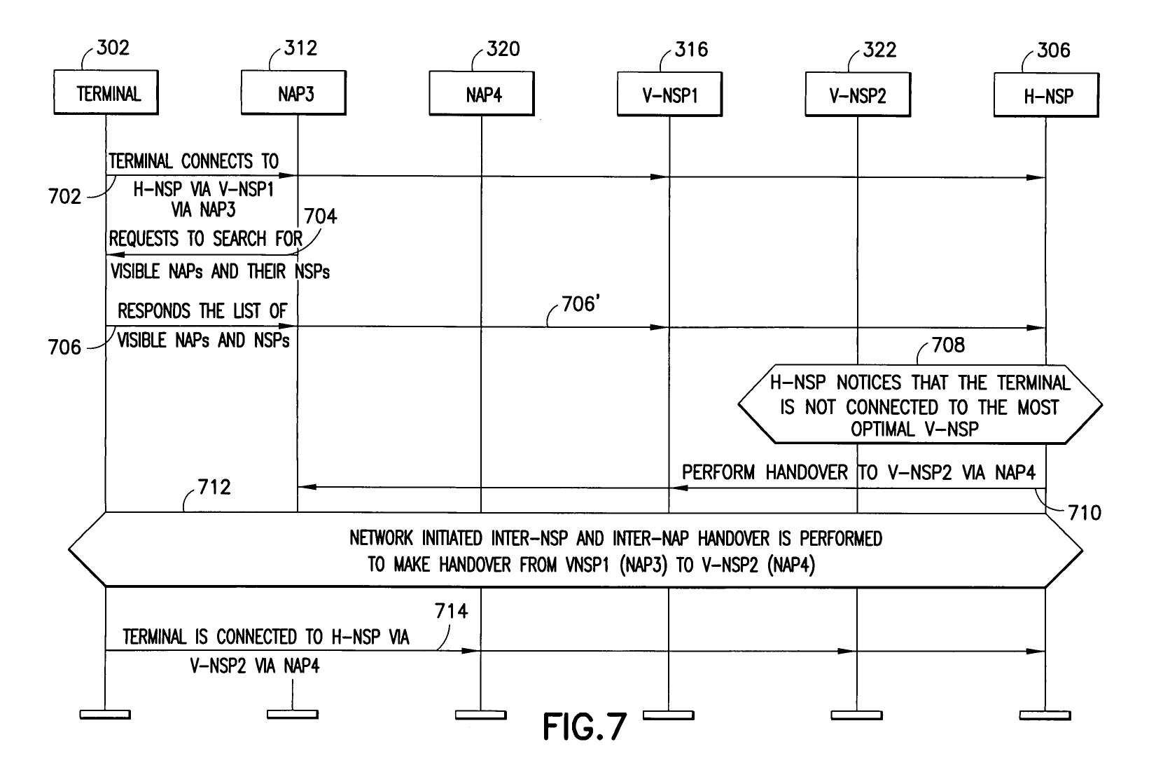

At FIG. 7 is illustrated an example of a network initiated handover from one V-NSP to a preferred V-NSP. As with FIG. 6, in FIG. 7 the subscriber terminal 302 sees both the third NAP 312 and the fourth NAP 320. The terminal 302 first connects to the H-NSP 302 via the first V-NSP 316 and the third NAP 312, and then the network initiates a handover to the second V-NSP 322 via the fourth NAP 320 because it is more preferred according to H-NSP 306 policies.

Method steps that may be used to execute the signaling diagram of FIG. 7 are as follows:
a) The subscriber terminal 302 starts to search for available networks and sees that the third NAP 312 is available. The terminal 302 connects 702 to the H-NSP 302 via the first V-NSP 316 and the third NAP 312, either by just trying its luck and connecting to the best available signal, or by getting information about V-NSPs that the H-NSP 306 supports such as in a SBC-RSP message as noted above.
b) The third NAP 312 requests 704 that the terminal 302 search for visible NAPs (e.g. by means of normal scanning procedure, such as the MOB_SCN-RSP message) and their supported NSPs as detailed in Appendix A of the provisional US patent application that is priority to this one. The request 704 may have originally come from the H-NSP 306 to the first V-NSP 316 and then forwarded to the third NAP 312.
c) The subscriber terminal 302 responds 706 with the list of visible NAPs and their supported NSPs (e.g. by means of a MOB_SCN-REP message) to the third NAP 312, which forwards 706′ the information to the first V-NSP 316 and further to the H-NSP 302. When the third NAP 312 forwards 706′ this information, the NSPs connected to the third NAP 312 can be added to the data list if not already present. Also, if the third NAP 312 has information about NSPs connected to surrounding NAPs, they could be included as well by the third NAP 312 in the list that it forwards 706′.
d) The H-NSP 306 gets the list of NAPs and their NSPs, and notices 708 from its RAPL that the terminal 302 is not connected to the most preferred NSP, which in these examples is the second V-NSP 322.
e) The H-NSP 306 initiates a handover from the first V-NSP 316 to the second V-NSP 322 by commanding 710 the first V-NSP 316 to make it, which the second V-NSP 316 does with the help of the third NAP 312.
f) The Network initiated inter-NSP and inter-NAP handover 712 is performed normally. If inter-NSP handover is not possible, the network needs means to indicate to the terminal 302 the need for changing the NSP. This can be done, e.g. by adding features to WiMAX MAC messages, or to Mobile IP messages.
g) The result 714 is that the terminal 302 is connected to the H-NSP 306 via the second V-NSP 322 via the fourth NAP 320, which is preferred over the second V-NSP 316.

The subscriber terminal 302 can connect directly to the most preferred V-NSP in the same area whenever it tries to enter to the network at a later time/date because the network has forced a handover to the second V-NSP 322 rather than keeping the connection to the first V-NSP 316. The terminal 302 stores this information in its local memory and thereby builds a RAPL for those V-NSPs for which the network has forced a handover (or has not attempted to force a handover) that mirror the RAPL of the H-NSP 306 in relevant parts. Also, the terminal 302 is able to perform inter-NSP handovers in that area to a more preferred V-NSP by accessing its local memory and the stored RAPL that it builds based on these network-initiated handovers and knowing that if a preferred V-NSP were not initially selected the network would initiate a handover to a different V-NSP. Hence, the terminal 302 learns the preferences while it traverses in different areas.

Steps b) through g) may possibly be performed after initial service flows have been established, or alternatively before the establishment of those service flows to avoid re-location of the data paths (and possibly other components) and the starting of accounting. Also, the selection of the HA could be made only after step f) to avoid possible relocation of it.

Now are described some additional/alternate scenarios that may occur that differ from those detailed above. In one additional scenario, the third NAP 312 is supported by both the first V-NSP 316 and the second V-NSP 322. In the event that the subscriber terminal 302 connects to the first V-NSP 316 via the third NAP 312, then the embodiments of FIGS. 5 and 6 are fully operable, but simplified in that only an inter-NSP handover is needed without an accompanying inter-NAP handover. The result after inter-NSP would be that the subscriber terminal 302 is coupled to the H-NSP 306 through the second V-NSP 322 and the third NAP 312, where the second V-NSP 322 is preferred over the first V-NSP 316.

Another additional scenario is the subscriber terminal 302 sees both the first NAP 308 and the third NAP 312 (see FIG. 3), and couples initially to the H-NSP 306 through the first V-NSP 316 and the third NAP 312. The embodiments of FIGS. 5 and 6 also are fully operable, and in this case the handover is both inter-NSP and inter-NAP, changing the terminal's 302 connection from the third NAP 312 and the first V-NSP 316 to the first NAP 308 and the H-NSP 306.

It can be seen from the above detailed examples that an advantage of embodiments of this invention is that there is no need for the network to update a CAPL and RAPL of all the terminals whenever the contractual or roaming agreements change or when new agreements are written. To the extent that any terminal stores a subset of the CAPL or RAPL, that subset is particularly tailored to the historic usage of that particular terminal, and any updates can be made according to the signaling diagrams shown above on an as needed basis when the terminal makes a selection other than that most preferred by the H-NSP. Additionally, bandwidth on the air interface is saved because updating traffic is reduced and also traffic inside the network is decreased. The individual terminals save memory because they do not have to store an entire CAPL and/or RAPL, only those truncated lists tailored (by the network for the area in which they connect, or by themselves due to building their own local lists) to their individual usage history.

Further advantage can be gained by delaying the start of accounting until after the handovers detailed herein, so that the NAP/V-NSP with which the terminal makes initial contact but that quickly hands over the terminal to a more preferred NAPN-NSP does not bill for that minimal time and slight resources used. Such would incur large transaction costs for minimal renumeration. An agreement among all the V-NSPs to forgo billing for an initial network entry that lasts less than a pre-determined period of time would avoid such accounting overhead. Some NAPs might not agree to a similar provision amongst themselves since that would reflect revenue loss without a corresponding offset for the case where an NAP is not also owned and operated by a NSP, and so NAPs could agree to bill only their NSP in those instances. It is in the interest of the NSPs to agree because any revenue loss from failing to invoice another NSP after handing over a newly established terminal would on average be offset by not being invoiced for a corresponding situation where another terminal was quickly handed over to that same NSP by another one.

The above details broader aspects of the invention. Below are detailed specific implementations of the small CAPL and/or RAPL preference lists that are sent to the terminals from the H-NSP, such as in message 404 of FIG. 4 or message 604 of FIG. 6. However, these structures may also be used if the full CAPL and RAPL are utilized instead of the small CAPL and RAPL as discussed above. It is anticipated that these controllable CAPL and RAPL lists will be added to the WiMAX Device Management Object DMO. As detailed above, the CAPL and RAPL contain information about NAPs and NSPs, respectively, and the H-NSP preferences for them relative to one another. The short CAPL/RAPL sent from the network according to the terminal's area also have network preferences, but only for those NAPs and NSPs on the short list. In addition to the preferences of one NAP/NSP over another, an aspect of this invention introduces a special type of element, termed here for conciseness as “any”, which can be used to indicate that any network (NAP) or operator (NSP) that has connection to the home NSP can be used by the terminal.

While the specific structure of the RAPI-CAPL may take any of various forms according to these teachings, one particular structure of the RAPL and CAPL that may be added to the Network Access OMA DM Object, WiMAX specific OMA DM Object, some other OMA DM Object, or to the Client Provisioning tree is as follows.

Exemplary RAPL/CAPL Structure:

[1 . . . n]*[H-NSP-ID data]
1 NAP Node:
   [0 . . . n]*[NAP-ID data, type=preferred]
   [0 . . . n]*[NAP-ID data, type=forbidden]
   [0 . . . 1]*[NAP-ID data, type=any]
1*V-NSP Node:
   [0 . . . n]*[V-NSP-ID data, type=preferred]
      [0 . . . 1] NAP Node:
         [0 . . . n]*[NAP-ID data, type=preferred]
         [0 . . . n]*[NAP-ID data, type=forbidden]
         [0 . . . 1]*[NAP-ID data, type=any]
   [0 . . . n]*[V-NSP-ID data, type=forbidden]
   [0 . . . 1]*[V-NSP-ID data, type=any]

### Notation:

1*=one item
[0 . . . 1]*=zero or one item
[1 . . . n]*=one or more items
[0 . . . n]*=zero, one or more items

The RAPL and CAPL structure, such as that shown by example above, may be located in a WiMAX DM Object.

The main level in the structure shown at the first line represents the H-NSPs. The second level, with indents from (1*NAP Node) and (1*V-NSP Node), contains respectively the CAPL which includes the connections between the H-NSP and the NAPs in the terminal's area, and the RAPL which includes connections between the H-NSP and the V-NSPs in the terminal's area. Also, under each V-NSP, a CAPL for that V-NSP may be introduced, which is shown as “[0 . . . 1] NAP Node” in the fourth level of indentation above.

The general principle of this structure is straightforward. At the first line/level is given the ID of the H-NSP. Different ID numbers may apply to the same H-NSP in different geographic areas, so there may be more than one ID in this field even though there is only one SLA between the subscriber terminal and an NSP.

At the next level, first is shown 1*NAP Node, which lists the NAPs in the area according to preference type given by the H-NSP. Next in the second level is shown 1*V-NSP Node, which lists all the V-NSPs in the area according to those same preference types given by the H-NSP. Note that for the V-NSP preference type=preferred, there is also a listing of NAP-ID for each of the three indicated preference types. This is because the network may prefer one NAP over another of the same V-NSP (or forbid one NAP while allowing others of this V-NSP, or have no preference for one NAP of this V-NSP but indicate a preference for another NAP of this same V-NSP). The network preference types are detailed below.

All NAP and V-NSP items in the RAPL and CAPL may have a parameter characterized as preference type (or simply “type”), which can have the following values: “preferred”, “forbidden” and “any”. The value “preferred” is used to indicate that the terminal is allowed to connect to this network (NAP) or operator (NSP). For those NAPs and V-NSPs for which the type is “preferred”, they are listed in a preferred order so as to give relative preference one over the other. Also, for “preferred” type NAPs and V-NSPs, there may be an additional “preference_number” field which would indicate the actual preference. The advantage of this “preference_number” field would be the possibility to define NAPs and V-NSPs to be equally preferred. This would enable subscriber terminal to connect to any of those that have same “preference_number” value. If the “preference_number” field is used, then in one embodiment the order of the NAP/NSP indicates a further preference within the same value of preference_number, and in another embodiment the order of the NAPs/NSPs in the respective list can be disregarded and only the preference_number used to determine relative preference. Type=“Forbidden” is used to tell the terminal that this network (NAP) or operator (NSP) must not be connected. Type=“Any” indicates that any network (NAP) or operator (NSP) can be used, with any exceptions given by type=forbidden in the same list.

If a NAP or V-NSP node is mandatory, then there must be at least one sub-node. The H-NSP-ID, V-NSP-ID and NAP-ID data may contain the following parameters in addition to type: NAP/NSP ID, band class, central frequency, channel bandwidth, Fast Fourier Transform (FFT) length, operator name, realm, authentication parameters, QoS parameters, supported service information, geographical area information and MIP (mobile Internet protocol) information.

The subscriber terminal 302 can implement the network selection logic indicated in the above CAPLs/RAPLs in the following way:
a) NAPs or NSPs, for which the indicated type=forbidden, must not be connected.
b) If the list does not contain type “any” for an NAP/NSP, the terminal must use only those NAPs or NSPs indicated as type=preferred, and in the preference order.
c) If the list contains type=any and also type=preferred for NAPs and/or NSPs, the terminal must try to connect to the network (NAP) or operator (NSP) using preferred connections. If preferred connections are not found, the terminal can use any NAP that has connection to the H-NSP. If no NAPs are found, the terminal can use any V-NSP that has a connection to the H-NSP. The terminal can know which V-NSP(s) are connected to the H-NSP by any number of means, such as that noted above and stipulated by example in Appendix A of the provisional US patent application that is priority to this one.
d) If the terminal does not find any preferred networks (NAPs) or operators (NSPs), and there are other networks or operators available, and an NAP or V-NSP node contains an item having type=any, the terminal can request updates to the RAPL and CAPL lists from the network.

The network operates with the CAPL/RAPL as follows:
a) The NSP operator can update the RAPL and CAPL lists based on the location of the terminal. If full RAPL and CAPL are deployed, then location information is not taken into account.
b) The NSP operator can trigger an RAPL and/or CAPL list update, when the terminal connects to a NAP or NSP that is not a preferred NAP or NSP as compared to other more preferred NAPs or NSPs in the terminal's area, as detailed above. If full RAPL and CAPL are deployed, then RAPL and CAPL updates may be triggered whenever they change.

As can be seen, these implementations provide a highly flexible and bandwidth efficient way for the terminals to execute the preferences of the H-NSP with regards to NAPs and V-NSPs.

In accordance with the exemplary embodiments of this invention related to the subscriber terminal, there is provided a method, apparatus and computer program embodied on a computer readable memory for accessing a wireless network according to a home service provider preference policy. The terminal determines several access nodes and one or more service providers associated with each of those access nodes, determines a preference for one of the service providers and one of the access nodes, and establishes itself on a wireless network through the determined preferred service provider and determined preferred access node. In one embodiment the terminal uses a downloaded list of service providers and access nodes having a connection to a home service provider, and establishes itself as above by requesting a handover to the determined preferred access node and/or service provider. The downloaded list is specific to the area in which the terminal is located. Such a downloaded list may include preference types for the service providers and/or access nodes, including ‘preferred’, ‘forbidden’ and ‘any’. Certain rules are followed as to how the terminal selects one service provider and access point over others based on the preference type and ranking/hierarchy for those with type=preferred. In another embodiment the terminal determines the preferred service provider and preferred access node based on a handover of the terminal from a first access node and/or service provider to the preferred access node or service provider and determines from this network-initiated handover the preference of one over the other. In both cases the terminal stores the preference in a local memory.

Further in accordance with the exemplary embodiments of this invention related to the network, there is provided a method, apparatus and computer program embodied on a computer readable memory for imposing on a subscriber terminal a home service provider's preference policy for access provider and service provider. Upon connection to an access provider and service provider (including the home service provider) having a connection to the home network service provider, the home service provider determines if the terminal is connected to the home service provider via a most preferred pathway. If it is determined that the terminal is connected to the home service provider via the most preferred pathway, no further action is taken by the home service provider respecting the preference policy. If it is determined that the terminal is not connected to the home service provider via the most preferred pathway, the home network service provider downloads (via the pathway along which the terminal is connected) a list of access providers and a list of service providers, where each of these lists is tailored to the area in which the terminal is currently located. The tailored list may be centered on the current terminal location, or merely include the terminal location and be truncated to a finite number of access providers to include an access provider to which the terminal has the capacity to connect with. As above, in an embodiment this list/these lists include a preference type, and the list includes type=preferred in a hierarchical order of preference, type=forbidden for access providers or service providers to which the terminal is not to connect, and type=any for which no specific hierarchical preference is indicated but connection by the terminal is allowed. For the case where there are both type=preferred and type=any, the preference is hierarchical by type=preferred and thereafter, if no connection with a type=preferred access provider or service provider is available to the terminal, the terminal is allowed to connect to a type=any access provider or service provider.

Further, while described in the context of WiMAX and described subscriber terminal 302/UE 10 and NAPs/NSPs, those descriptions are by example only and it is within the scope of the exemplary embodiments of this invention to use these teachings in any wideband wireless system where access providers (e.g., NAPs) may not always be under control of or operated by a single network service provider, where roaming agreements alone do not give the business relation between access providers and network service providers.

In general, the various embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams and signaling diagrams, it is well understood that these blocks, apparatus, systems, signals and methods described herein may be implemented in, as non-limiting examples, hardware, software, firmware, special purpose circuits or logic, general purpose hardware or controller or other computing devices, or some combination thereof. The signaling diagrams are specifically indicative of method steps executed by the various nodes, in the order given when one step is responsive to or depends on a previous step.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

Various modifications and adaptations may become apparent to those skilled in the relevant arts in view of the foregoing description, when read in conjunction with the accompanying drawings. However, any and all modifications of the teachings of this invention will still fall within the scope of the non-limiting embodiments of this invention.

Furthermore, some of the features of the various non-limiting embodiments of this invention may be used to advantage without the corresponding use of other features. As such, the foregoing description should be considered as merely illustrative of the principles, teachings and exemplary embodiments of this invention, and not in limitation thereof.

We claim:

1. A method comprising:
determining that a terminal is connected to an access provider; and
sending to the terminal from the terminal's home service provider a list of access providers and a list of service providers, wherein the list of access providers indicates preferences of the listed access providers relative to one another and the list of service providers indicates preferences of the listed service providers relative to one another.

2. The method of claim 1, wherein one of the preferences in at least one of the list of access providers and the list of service providers is an indication that any access provider or any service provider that has connection to the terminal's home service provider can be used.

3. The method of claim 2, wherein the indications of preferences are preference types selected from the group {preferred, forbidden, any}.

4. The method of claim 3, wherein at least one of the list of access providers and the list of service providers further comprises an additional indication of relative preference among those providers having the same preference type.

5. The method of claim 1, wherein the list of access providers and the list of service providers is tailored to an area in which the terminal is determined to be operating.

6. The method of claim 1, further comprising:
sending to the terminal from the terminal's home service provider an updated list of access providers and an updated list of service providers that is updated for a changed location of the terminal.

7. The method of claim 1, wherein sending to the terminal the list of access providers and the list of service providers is automatically responsive to determining that the terminal is connected to at least one of a network access provider that is not preferred by the terminal's home service provider and a network service provider that is not preferred by the terminal's home service provider.

8. An apparatus comprising a processor executing a program stored in a memory that operate to determine that a terminal is connected to an access provider, and to send to the terminal a list of access providers and a list of service providers, wherein the list of access providers indicates preferences of the listed access providers relative to one another and the list of service providers indicates preferences of the listed service providers relative to one another.

9. The apparatus of claim 8, wherein one of the preferences in at least one of the list of access providers and the list of service providers is an indication that any access provider or any service provider that has connection to the terminal's home service provider can be used, and wherein the apparatus comprises the terminal's home service provider.

10. The apparatus of claim 9, wherein the indications of preferences are preference types selected from the group {preferred, forbidden, any}.

11. The apparatus of claim 10, wherein at least one of the list of access providers and the list of service providers further comprises an additional indication of relative preference among those providers having the same preference type.

12. The apparatus of claim 8, wherein the list of access providers and the list of service providers is tailored to an area in which the terminal is determined to be operating.

13. The apparatus of claim 8, wherein the apparatus is configured to send to the terminal an updated list of access providers and an updated list of service providers that is updated for a changed location of the terminal.

14. The apparatus of claim 8, wherein the apparatus is configured to send to the terminal the list of access providers and the list of service providers automatically in response to the apparatus determining that the terminal is connected to at least one of a network access provider that is not preferred by the terminal's home service provider and a network service provider that is not preferred by the terminal's home service provider.

15. A method comprising:
receiving a list of access providers and a list of service providers, wherein the list of access providers indicates preferences by a terminal's home service provider of the listed access providers relative to one another and the list of service providers indicates preferences by the terminal's home service provider of the listed service providers relative to one another; and
connecting to an available access provider and to an available service provider according to the indicated preferences.

16. The method of claim 15, wherein one of the preferences in at least one of the list of access providers and the list of service providers is an indication that any access provider or any service provider that has connection to the terminal's home service provider can be used.

17. The method of claim 16, wherein the indications of preferences are preference types selected from the group {preferred, forbidden, any}.

18. The method of claim 17, wherein at least one of the list of access providers and the list of service providers further comprises an additional indication of relative preference among those providers having the same preference type.

19. The method of claim 15, wherein the list of access providers and the list of service providers is received in at least one device management object DMO.

20. The method of claim 19, wherein the list of access providers and the list of service providers is received in the form:
[1 . . . n]*[H-NSP-ID data]
1*NAP Node:
[0 . . . n]*[NAP-ID data, type=preferred]
[0 . . . n]*[NAP-ID data, type=forbidden]
[0 . . . 1]*[NAP-ID data, type=any]
1*V-NSP Node:
[0 . . . n]*[V-NSP-ID data, type=preferred]
[0 . . . 1] NAP Node:
[0 . . . n]*[NAP-ID data, type=preferred]
[0 . . . n]*[NAP-ID data, type=forbidden]
[0 . . . 1]*[NAP-ID data, type=any]
[0 . . .n]*[V-NSP-ID data, type=forbidden]
[0 . . . 1]*[V-NSP-ID data, type=any]
where 1* indicates one item; [0 . . . 1]* indicates zero or one item; [1 . . . n]* indicates one or more items; and [0 . . . n]* indicates zero, one or more items; and further wherein H-NSP is the terminal's home network service provider, V-NSP is a visited network service provider, NAP is a network access provider, entries under the heading 1*NAP Node comprise the list of access providers and entries under 1*V-NSP Node comprise the list of service providers.

21. The method of claim 15, wherein the list of access providers and the list of service providers is tailored to an area in which the terminal is operating at the time the list is received.

22. The method of claim 15, wherein at least one of the list of access providers and the list of service providers comprises, in addition to an identifier for the said access or service providers, at least one parameter selected from the group {band class, central frequency, channel bandwidth, fast Fourier transform length, operator name, operator realm, authentication parameters, quality of service parameters, supported service information, geographical area information, and mobile internet protocol information}; and further wherein connecting to at least one of the available access provider and the available service provider is further according to the parameters.

23. The method of claim 15, further comprising:
receiving an updated list of access providers and an updated list of service providers that is updated for a changed location of the terminal.

24. The method of claim 15, wherein the list of access providers and the list of service providers is received after connecting to at least one of a network access provider that is not preferred by the terminal's home service provider and a network service provider that is not preferred by the terminal's home service provider as indicated on the respective received list.

25. The method of claim 24, wherein connecting to at least one of a network access provider that is not preferred by the terminal's home service provider and a network service provider that is not preferred by the terminal's home service provider comprises connecting to a first available network without reference to a stored list of access providers or service providers.

26. The method of claim 24, wherein connecting to at least one of an available access provider and to an available service provider according to the indicated preferences is in response to receiving the list of access providers and the list of service providers, and comprises a terminal initiated handover.

27. The method of claim 24, wherein connecting to at least one of an available access provider and to an available service provider according to the indicated preferences is in response to receiving the list of access providers and the list of service providers, and comprises a network initiated handover.

28. An apparatus comprising:
a receiver configured to receive a list of access providers and a list of service providers, wherein the list of access providers indicates preferences by a terminal's home service provider of the listed access providers relative to one another and the list of service providers indicates preferences by the terminal's home service provider of the listed service providers relative to one another; and
a transmitter, processor and a memory that with the receiver are configured to connect to an available access provider and to an available service provider according to the indicated preferences.

29. The apparatus of claim 28, wherein one of the preferences in at least one of the list of access providers and the list of service providers is an indication that any access provider or any service provider that has connection to the terminal's home service provider can be used, and wherein the apparatus comprises the terminal.

30. The apparatus of claim 29, wherein the indications of preferences are preference types selected from the group {preferred, forbidden, any}.

31. The apparatus of claim 30, wherein at least one of the list of access providers and the list of service providers further comprises an additional indication of relative preference among those providers having the same preference type.

32. The apparatus of claim 28, wherein the receiver receives the list of access providers and the list of service providers in at least one device management object DMO.

33. The apparatus of claim 32, wherein the list of access providers and the list of service providers is in the form:
[1 . . .n]*[H-NSP-ID data]
1*NAP Node:
[0 . . . n]*[NAP-ID data, type=preferred]
[0 . . . n]*[NAP-ID data, type=forbidden]
[0 . . . 1]*[NAP-ID data, type=any]
1*V-NSP Node:
[0 . . . n]*[V-NSP-ID data, type=preferred]
[0 . . . 1]NAP Node:
[0 . . . n]*[NAP-ID data, type=preferred]
[0 . . . n]*[NAP-ID data, type=forbidden]
[0 . . . 1]*[NAP-ID data, type=any]
[0 . . . n]*[V-NSP-ID data, type=forbidden]
[0 . . . 1]*[V-NSP-ID data, type=any]
where 1* indicates one item; [0 . . . 1]* indicates zero or one item; [1 . . . n]* indicates one or more items; and [0 . . . n]* indicates zero, one or more items; and further wherein H-NSP is the terminal's home network service provider, V-NSP is a visited network service provider, NAP is a network access provider, entries under the heading 1*NAP Node comprise the list of access providers and entries under 1*V-NSP Node comprise the list of service providers.

34. The apparatus of claim 28, wherein the list of access providers and the list of service providers is tailored to an area in which the terminal is operating at the time the receiver receives the list.

35. The apparatus of claim 28, wherein at least one of the list of access providers and the list of service providers comprises, in addition to an identifier for the said access or service providers, at least one parameter selected from the group {band class, central frequency, channel bandwidth, fast Fourier transform length, operator name, operator realm, authentication parameters, quality of service parameters, supported service information, geographical area information, and mobile internet protocol information}; and further wherein connecting to at least one of the available access provider and the available service provider is further according to the parameters.

36. The apparatus of claim 28, wherein the receiver is further configured to receive an updated list of access providers and an updated list of service providers that is updated for a changed location of the terminal.

37. The apparatus of claim 28, wherein the receiver receives the list of access providers and the list of service providers after the apparatus connects to at least one of a network access provider that is not preferred by the terminal's home service provider and a network service provider that is not preferred by the terminal's home service provider as indicated on the respective received list.

38. The apparatus of claim 37, wherein the apparatus connects to at least one of a network access provider that is not preferred by the terminal's home service provider and a network service provider that is not preferred by the terminal's home service provider by connecting to a first available network without reference to a stored list of access providers or service providers.

39. The apparatus of claim 37, wherein the apparatus connects to at least one of an available access provider and to an available service provider according to the indicated preferences using a terminal initiated handover in response to the receiver receiving the list of access providers and the list of service providers.

40. The apparatus of claim 37, wherein the apparatus connects to at least one of an available access provider and to an available service provider according to the indicated preferences using a network initiated handover in response to receiving the list of access providers and the list of service providers.

41. A computer readable memory embodying a program of machine-readable instructions executable by a digital data processor to perform actions directed toward connecting to a preferred access provider and to a preferred service provider, the actions comprising:
in response to receiving a list of access providers and a list of service providers, wherein the list of access providers indicates preferences by a terminal's home service provider of the listed access providers relative to one another and the list of service providers indicates preferences by the terminal's home service provider of the listed service providers relative to one another, connecting to an available access provider and to an available service provider according to the indicated preferences.
